(19) United States
(12) Patent Application Publication
(10) Pub. No.: US 2026/0281306 A1
(43) Pub. Date: Sep. 17, 2026

(54) Method and Apparatus of Temporal Candidates for Cross-Component Model Merge Mode in Video Coding System

(71) Applicant: MEDIATEK INC., Hsinchu City (TW)

(72) Inventors: Hsin-Yi TSENG, Hsinchu City (TW); Chia-Ming TSAI, Hsinchu City (TW); Cheng-Yen CHUANG, Hsinchu City (TW); Ching-Yeh CHEN, Hsinchu City (TW); Chih-Wei HSU, Hsinchu City (TW); Yi-Wen CHEN, San Jose, CA (US); Tzu-Der CHUANG, Hsinchu City (TW)

(21) Appl. No.: 19/471,006

(22) PCT Filed: Apr. 18, 2024
(86) PCT No.: PCT/CN2024/088483

§ 371 Date: Sep. 30, 2025

Related U.S. Application Data
(60) Provisional application No. 63/496,704, filed on Apr. 18, 2023.

(51) Int. Cl. H04N 19/105; H04N 19/159; H04N 19/186; H04N 19/196; H04N 19/52

(52) U.S. Cl. CPC H04N 19/105; H04N 19/159; H04N 19/186; H04N 19/196; H04N 19/52

(57) ABSTRACT

A method and apparatus for deriving a motion vector from a neighboring block to determine a temporal candidate and inheriting cross-component models from two or more previous coded pictures for cross-component prediction. According to one method, a target motion vector is determined based on a neighbouring block and a temporal candidate is determined based on the target motion vector for inclusion in a candidate list. According to another method, a plurality of collocated pictures for the current block is determined and a temporal candidate is determined based on two or more collocated pictures.

### CROSS REFERENCE TO RELATED APPLICATIONS

The present invention is a Non-Provisional Application of and claims priority to U.S. Provisional Patent Application No. 63/496,704, filed on Apr. 18, 2023. The U.S. Provisional Patent Application is hereby incorporated by reference in its entirety.

### FIELD OF THE INVENTION

The present invention relates to video coding system. In particular, the present invention relates to deriving a motion vector from a neighboring block to determine a temporal candidate or inheriting cross-component models from two or more previous coded pictures.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology−Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Some new tools relevant to the present invention are reviewed as follows.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i,j) represents the predicted chroma samples in a CU and rec_{L}′(i,j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM_LA mode is applied and both above and left neighbouring samples are available;
S[W′/8, −1],S[3*W′/8, −1],S[5*W′/8, −1],S[7*W′/8, −1] when LM_A mode is applied or only the above neighbouring samples are available;
S[−1,H′/8],S[−1,3*H′/8],S[−1,5*H′/8],S[−1,7*H′/8] when LM_L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${x}_{A} = ( {x}_{A}^{0} + {x}_{A}^{1} + 1 ) ≫ 1 ; \qquad ( 2 )$$

$${x}_{B} = ( {x}_{B}^{0} + {x}_{B}^{1} + 1 ) ≫ 1 ;$$

$${y}_{A} = ( {y}_{A}^{0} + {y}_{A}^{1} + 1 ) ≫ 1 ;$$

$${y}_{B} = ( {y}_{B}^{0} + {y}_{B}^{1} + 1 ) ≫ 1$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

FIG. 2 shows an example of the location of the left and above samples and the sample of the current block involved in the LM_LA mode. FIG. 2 shows the relative sample locations of N×N chroma block 210, the corresponding 2N×2N luma block 220 and their neighbouring samples (shown as filled circles).

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only left template are used to calculate the linear model coefficients. To get more samples, the left template is extended to (H+W) samples.

In LM_LA mode, left and above templates are used to calculate the linear model coefficients.

The terms of {LM_LA, LM_L, LM_A} and {CCLM_LT, CCLM_L, CCLM_T} are used interchangeably in this disclosure.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS (Sequence Parameter Set) level flag. The two down-sampling filters are as follows, which are corresponding to “type-0” and “type-2” content, respectively.

$${Rec}_{L}^{′} ( i , j ) = [ {rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] ≫ 3 \qquad ( 5 )$$

$${Rec}_{L}^{′} ( i , j ) = {rec}_{L} ( 2 i , 2 j - 1 ) + {rec}_{L} ( 2 i - 1 , 2 j ) + 4 \cdot {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad ( 6 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the a and p values to the decoder.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and p are derived for a particular group). Furthermore, the samples of the current luma block are also classified based on the same rule for the classification of neighbouring luma samples. Three MMLM model modes (including MMLM_LA, MMLM_T, and MMLM_L) are allowed for choosing the neighbouring samples from left-side and above-side, above-side only, and left-side only, respectively.

The term MMLM_LA and MMLM_LT are used interchangeably in this disclosure.

FIG. 3 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}^{′} [ x , y ] \leq Threshold \\ ( {Pred}_{C} [ x , y ] = {α}_{2} \times {Rec}_{L}^{′} [ x , y ] + {β}_{2} & if {Rec}^{′} [ x , y ] > Threshold\end{matrix} \qquad ( 7 )$$

### Convolutional Cross-Component Model (CCCM)−Single Model and Multi-Model

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south (S), left/west (W) and right/east (E) neighbours as shown in FIG. 4.

The nonlinear term (denoted as P) is represented as power of two of the centre luma sample C and scaled to the sample value range of the content:

$$P = ( C * C + midVal ) ≫ bitDepth .$$

For example, for 10-bit contents, the nonlinear term is calculated as:

$$P = ( C * C + 512 ) ≫ 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients ci are calculated by minimising MSE between predicted and reconstructed chroma samples in the reference area. FIG. 5 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 5 and are padded when in unavailable areas.

The MSE minimization is performed by calculating autocorrelation matrix for the luma input and a cross-correlation vector between the luma input and chroma output.

Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Gradient Linear Model (GLM)

For YUV 4:2:0 colour format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signalling, when the CCLM mode is enabled to the current CU, one flag is signalled to indicate whether GLM is enabled for both Cb and Cr components; if the GLM is enabled, another flag is signalled to indicate which of the two GLM modes is selected and one syntax element is further signalled to select one of 4 gradient filters (610-640 in FIG. 6) for the gradient calculation.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 710 are selected among candidates located in the positions depicted in FIG. 7. The order of derivation is B₀, A₀, B₁, A₁ and B₂. Position B₂ is considered only when one or more neighbouring CU of positions B₀, A₀, B₁, A₁ are not available (e.g., belonging to another slice or tile) or is intra coded. After candidate at position A₁ is added, the addition of the remaining candidates is subject to a redundancy check which ensures that candidates with the same motion information are excluded from the list so that coding efficiency is improved.

### Temporal Candidates Derivation

In this step, only one candidate is added to the list. Particularly, in the derivation of this temporal merge candidate for a current CU 810, a scaled motion vector is derived based on the co-located CU 820 belonging to the collocated reference picture as shown in FIG. 8. The reference picture list and the reference index to be used for the derivation of the co-located CU is explicitly signalled in the slice header. The scaled motion vector 830 for the temporal merge candidate is obtained as illustrated by the dotted line in FIG. 8, which is scaled from the motion vector 840 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 9. If CU at position C₀ is not available, is intra coded, or is outside of the current row of CTUs, position C₁ is used. Otherwise, position C₀ is used in the derivation of the temporal merge candidate.

### Non-Adjacent Spatial Candidate

The non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP (i.e., the temporal MVP) in the regular merge candidate list. The pattern of spatial merge candidates is shown in FIG. 10. The distances between non-adjacent spatial candidates and current coding block are based on the width and height of current coding block. The line buffer restriction is not applied.

In the present invention, methods and apparatus to derive cross-component prediction models for non-intra coded blocks based on two or more collocated pictures. In addition, methods and apparatus to derive a motion vector from a neighboring block to determine a temporal candidate.

### BRIEF SUMMARY OF THE INVENTION

A method and apparatus for deriving a motion vector from a neighboring block to determine a temporal candidate are disclosed. According to the method, input data associated with a current block comprising a first-colour block and a second-colour block are received, wherein the input data comprise pixel data to be encoded at an encoder side or data associated with the current block to be decoded at a decoder side, and wherein the current block is in a non-intra slice or picture. A target motion vector is determined based on one or more neighbouring blocks of the current block. A temporal candidate is determined based on the target motion vector, wherein a target cross-component model is generated for the second-colour block by using one or more cross-component model parameters associated with the temporal candidate. A candidate list comprising the temporal candidate is determined. The second-colour block is encoded or decoded using the candidate list, wherein cross-component prediction data are generated for the second-colour block according to the target cross-component model when the temporal candidate is selected.

In one embodiment, said one or more neighbouring blocks are located at one or more pre-defined positions. In one embodiment, the target motion vector selected corresponds to a L0 or L1 motion vector. In one embodiment, if a target neighbouring block of said one or more neighbouring blocks is not an inter block, the target neighbouring block of said one or more neighbouring blocks is not selected for the current block for said determining the temporal candidate.

In one embodiment, said one or more neighbouring blocks of the current block correspond to a list of pre-defined positions and a target neighbouring block is selected from the list of pre-defined positions according to a pre-defined checking order. In one embodiment, the target neighbouring block corresponds to a first position being an inter block in the list of pre-defined positions. In another embodiment, the target neighbouring block corresponds to a first position in the list of pre-defined positions, and wherein the first position has a reference picture as a collocated picture of the current block.

In one embodiment, the target cross-component model is inherited from a previously coded picture and the previously coded picture is selected from reference pictures in one or more reference lists. In one embodiment, a target reference picture selected from the reference pictures in said one or more reference lists is signalled in a picture or slice header.

In one embodiment, a target reference picture is selected implicitly from the reference pictures in said one or more reference lists according to a set of pre-defined rules. In one embodiment, the set of pre-defined rules comprises selecting a candidate reference picture that has a smallest POC (Picture Order Count) difference or a smallest QP (Quantization Parameter) difference between respective reference pictures and a current picture, or has a smallest QP among the reference pictures as the target reference picture. In another embodiment, the set of pre-defined rules comprise selecting a candidate reference picture that corresponds to a most recently coded I-picture as the target reference picture.

A method and apparatus for inheriting cross-component models from two or more previous coded pictures are disclosed. According to this method, input data associated with a current block comprising a first-colour block and a second-colour block are received, wherein the input data comprise pixel data to be encoded at an encoder side or data associated with the current block to be decoded at a decoder side, and wherein the current block is in a non-intra slice or picture. A plurality of collocated pictures for the current block is determined, wherein the plurality of collocated pictures correspond to previous coded pictures. A temporal candidate is determined based on two or more collocated pictures, wherein a target cross-component model is derived by inheriting one or more cross-component model parameters from said two or more collocated pictures. A candidate list comprising the temporal candidate is determined. The second-colour block is encoded or decoded using the candidate list, wherein cross-component prediction data are generated for the second-colour block according to the target cross-component model when the temporal candidate is selected.

In one embodiment, a total number for the plurality of collocated pictures is signalled or parsed in a bitstream. In one embodiment, the total number for the plurality of collocated pictures is signalled or parsed in PH (Picture Header), SH (Slice Header), PPS (Picture Parameter Set) or SPS (Sequence Parameter Set) of the bitstream.

In one embodiment, the plurality of collocated pictures corresponds to a picture set consisting of N previous coded pictures. In one embodiment, one target index is signalled or parsed from a bitstream to indicate one of said two or more collocated pictures selected from the picture set. In one embodiment, an index for a member picture in the picture set has a smaller value if POC (Picture Order Count) difference between the member picture and a current picture is smaller. In one embodiment, an index for a member picture in the picture set has a smaller value if picture-level QP (Quantization Parameter) difference between the member picture and a current picture is smaller. In another embodiment, an index for a member picture in the picture set has a smaller value if picture-level QP of the member picture is smaller. In yet another embodiment, an index for a member picture in the picture set has a smaller value if picture-level QP of the member picture is larger.

In one embodiment, said two or more collocated pictures are selected from the picture set according to a set of pre-defined rules. In one embodiment, the set of pre-defined rules corresponds to selecting one or more candidate pictures from the picture set with a smaller QP, larger QP, smaller QP difference from a current picture, smaller POC difference from a current picture, and/or a combination thereof.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows an example of the location of the left and above samples and the sample of the current block involved in the LM_LA mode.

FIG. 3 shows an example of classifying the neighbouring samples into two groups.

FIG. 4 illustrates an example of spatial part of the convolutional filter.

FIG. 5 illustrates an example of reference area with paddings used to derive the filter coefficients.

FIG. 6 illustrates the 4 gradient patterns for Gradient Linear Model (GLM).

FIG. 7 illustrates the neighbouring blocks used for deriving spatial merge candidates for VVC.

FIG. 8 illustrates an example of temporal candidate derivation, where a scaled motion vector is derived according to POC (Picture Order Count) distances.

FIG. 9 illustrates the position for the temporal candidate selected between candidates C₀ and C₁.

FIG. 10 illustrates an exemplary pattern of the non-adjacent spatial merge candidates.

FIG. 11 illustrates an example of inheriting temporal neighbouring model parameters.

FIG. 12 illustrates an example of temporal candidate positions according to one embodiment of the present invention.

FIGS. 13A-B illustrate two search patterns for inheriting non-adjacent spatial neighbouring models.

FIG. 14 illustrates a flowchart of an exemplary video coding system that derives a motion vector from a neighboring block to determine a temporal candidateaccording to an embodiment of the present invention.

FIG. 15 illustrates a flowchart of an exemplary video coding system that inherits cross-component models from two or more previous coded pictures according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of cross-component prediction, various schemes related to inheriting cross-component models are disclosed.

### Inheriting Neighbouring Model Parameters

When applying cross-component prediction coding tool on the current block to generate prediction signals, the cross-component model (CCM) information (more details in section entitled: “Inheriting CCM Information”) including model parameters can be inherited from neighbouring blocks. More details of neighbouring blocks are described in sections entitled: “Inheriting Spatial Neighbouring Model Parameters”, “Inheriting Temporal Neighbouring Model Parameters”, “Inheriting Non-Adjacent Spatial Neighbouring Models” and “Inheriting Model Parameters from History Table”.

The final scaling parameter of the current block is inherited from the neighbouring blocks and/or further refined by dA. Once the final scaling parameter is determined, the offset parameter (e.g., β in CCLM) is derived based on the inherited scaling parameter and/or the average value of neighbouring luma and chroma samples of the current block. For example, if the final scaling parameter is inherited from a selected neighbouring block, and the inherited scaling parameter is α′ₙₑᵢ, then the final scaling parameter is (α′ₙₑᵢ+dA). For yet another embodiment, the final scaling parameter is inherited from a historical list and/or further refined by dA. For example, the historical list records the most recent j entries of final scaling parameters from previous CCLM-coded blocks. Then, the final scaling parameter is inherited from one selected entry of the historical list, α′ₗᵢₛₜ, and the final scaling parameter is (α′ₕᵢₛₜ+dA). For yet another embodiment, the final scaling parameter is inherited from a historical list or the neighbouring blocks, but does not further refine by dA.

For yet another embodiment, after inheriting model parameters, the offset parameter can be further refined by dB. For example, if the final offset parameter is inherited from a selected neighbouring block, and the inherited offset parameter is

$${β}_{nei}^{′} ,$$

then the final offset parameter is

$$( {β}_{nei}^{′} + dB ) .$$

For still another embodiment, the final offset parameter is inherited from a historical list and further refined by dB. For example, the historical list records the most recent j entries of final offset parameters from previous CCLM-coded blocks. Then, the final offset parameter is inherited from one selected entry of the historical list,

$${β}_{list}^{′} ,$$

and the final offset parameter is

$$( {β}_{list}^{′} + dB ) .$$

For yet another embodiment, the final offset parameter is inherited from a historical list or the neighbouring blocks, but is not further refined by dB.

For yet another embodiment, if the inherited neighbour block is coded with CCCM, the filter coefficients (cᵢ) are inherited. The offset parameter (e.g., c₆×B or c₆ in CCCM) can be re-derived based on the inherited parameter and the average value of neighbouring corresponding position luma and chroma samples of the current block.

For still another embodiment, if the inherited candidate applies GLM gradient pattern to its luma reconstructed samples, the current block shall also inherit the GLM gradient pattern of the candidate and apply to the current luma reconstructed samples.

For still another embodiment, if the inherited neighbour block is coded with multiple cross-component models (e.g., MMLM, or CCCM with multi-model), the classification threshold is also inherited to classify the neighbouring samples of the current block into multiple groups, and the inherited multiple cross-component model parameters are further assigned to each group.

### Inheriting CCM Information

In one embodiment, the cross-component model (CCM) information of inherited cross-component model can be stored together with the inherited model parameters. As mentioned earlier in this disclosure, the CCM information includes, but not limited to prediction mode (e.g., CCLM, MMLM, CCCM), model index for indicating which model shape is used in the convolutional model, classification threshold for multi-model, down-sampling filter flag, down-sampling filtering index, the number of neighbouring lines used to derive model, types of templates used to derive model, post-filtering flag or model parameters.

In one embodiment, CCLM model can be inherited. In addition to storing model parameters, a prediction mode can be stored in the CCM information for indicating that the inherited model is a CCLM model.

In another embodiment, CCLM model with non-linear term can be inherited. In addition to storing model parameters, a prediction mode can be stored in the CCM information for indicating that the inherited model is a CCLM model with non-linear term.

In one embodiment, CCCM model can be inherited. In addition to storing model parameters, a prediction mode can be stored in the CCM information for indicating that the inherited model is a CCCM model. The luma offset and the chroma offset used for adjusting the input of CCCM model can also be stored in the CCM information.

In another embodiment, CCCM model with different convolution filter shape can be inherited. In addition to model parameters and prediction mode, a CCCM mode index can also be stored in CCM information for indicating which convolution filter shape is used for the inherited CCCM model. For example, a CCCM model with different convolution filter shape can only contain the spatial terms in the horizontal direction. For another example, a CCCM model with different convolution filter shape can only contain the spatial terms in the vertical direction. For another example, a CCCM model with different convolution filter shape can only contain the spatial terms in the diagonal direction. For another example, a CCCM model with different convolution filter shape can only contain the spatial terms in anti-diagonal direction. For another example, a CCCM model with different convolution filter shape can contain the X-shape spatial terms.

In another embodiment, CCCM model using non-downsampled samples can be inherited. In addition to storing model parameters, a prediction mode can be stored in the CCM information for indicating that the inherited model is a CCCM model using non-downsampled samples.

In another embodiment, CCCM model with multiple down-sampling filters can be inherited. In addition to storing model parameters, a prediction mode can be stored in the CCM information for indicating that the inherited model is a CCCM model with multiple down-sampling filters, and a model index can be also stored in CCM information for indicating which variant of CCCM model with multiple down-sampling filters is inherited.

In another embodiment, a mixed CCCM model consists of various terms (e.g., spatial term, gradient term, location term, non-linear term and bias term) can be inherited. The gradient term can be calculated in either the downsampled domain or the non-downsampled domain. The location term can be calculated with respect to the top-left coordinates of the current block or the picture. In addition to storing model parameters, a prediction mode can be stored in the CCM information for indicating that the inherited model is a mixed CCCM model consisting of various terms. If there are multiple types of mixed CCCM models, a model index can also be stored in the CCM information for indicating which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consist of one spatial term in centre position, two gradient terms for the horizontal direction and vertical direction, two location terms X and Y for the relative horizontal location and relative vertical location, one non-linear term and one bias term. In addition to storing model parameters, a prediction mode can be stored in the CCM information for indicating that the inherited model is a GL-CCCM model.

In one embodiment, GLM model can be inherited. In addition to storing model parameters, a prediction mode can be stored in the CCM information for indicating that the inherited model is a GLM model, and a down-sampling filtering index can be also stored in CCM information for indicating which gradient down-sampled filter is used for the inherited GLM model.

In another embodiment, GLM model with luma term can be inherited. In addition to storing model parameters, a prediction mode can be stored in the CCM information for indicating that the inherited model is a GLM model with luma term, and a down-sampling filtering index can also be stored in CCM information for indicating which gradient down-sampled filter is used for the inherited GLM model with luma term.

In one embodiment, any kind of cross-component multi-model can be inherited. In addition to storing model parameters and prediction mode, a multi-model on/off flag can be stored in the CCM information for indicating whether the inherited CCM model is a multi-model or not. If the multi-model on/off flag is true, the multi-model classification threshold is also stored in the CCM information.

In one embodiment, the CCM information can include information to indicate how the inherited model is derived. For example, the CCM information can include the number of neighbouring lines used to derive the cross-component model and/or the types of templates used to derive model. For example, a set of templates can be used to derive a CCCM model. The set of templates include template with different positions, sizes, and shapes. The CCM information can store the index of the template the inherited CCCM model was derived based on. For example, the inherited CCCM model can be derived based on a top-only template, or a left-only template or a left-and-top template. For another example, the inherited CCCM model can be derived based on a 6-line template or a 2-line template.

In one embodiment, a post-filter flag can be stored in the CCM information. This information describes how the inherited model is used in the block and where the inherited model is from. If the post-filter flag is on, this indicates a filter is applied to the prediction of the block the inherited model is from.

### Inheriting Spatial Neighbouring Model Parameters

For another embodiment, the inherited model parameters can be from a block that is an immediate neighbouring block. The models from blocks at pre-defined positions are added into the candidate list in a pre-defined order. For example, the pre-defined positions can be the positions depicted in FIG. 7, and the pre-defined order can be B₀, A₀, B₁, A₁ and B₂, or A₀, B₀, B₁, A₁ and B₂. The block can be a chroma block or a single-tree luma block.

In one embodiment, the pre-defined positions and the pre-defined order can be the same as those of spatial candidates for inter merge mode.

For still another embodiment, assume the position, width and height of the current block are (x, y), W and H respectively, the pre-defined positions include the positions at the immediate above (W>>1) or ((W>>1)−1) position (i.e., the positions immediate above the current block, such as (x+W>>1, y−1) or (x+(W+1)>>1, y−1)) if W is greater than or equal to TH, and the positions at the immediate left (H>>1) or ((H>>1)−1) position (i.e., positions immediate left to the current blocks, such as (x−1, y+H>>1) or (x−1, y+(H+1)>>1)) if H is greater than or equal to TH, where W and H are the width and height of the current block, TH is a threshold value which can be 2, 4, 8, 16, 32, or 64.

For still another embodiment, the maximum number of inherited models from spatial neighbours are smaller than the number of pre-defined positions. For example, if the pre-defined positions are as depicted in FIG. 7, there are 5 pre-defined positions. If pre-defined order is B₀, A₀, B₁, A₁ and B₂, and the maximum number of inherited models from spatial neighbours is 4, the model from B2 is added into the candidate list only when one of preceding blocks is not available or is not coded in cross-component model.

### Inheriting Temporal Neighbouring Model Parameters

In one embodiment, if the current slice/picture is a non-intra slice/picture, the inherited model parameters can be from the block in the previous coded slices/pictures.

For still another embodiment, if the current slice/picture is a non-intra slice/picture, the inherited model parameters can be from the block in the previously coded slices/pictures. For example, as shown in the FIG. 11, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previously coded slices/picture, where x′=x+Δx and y′=y+Δy. In one embodiment, if the prediction mode of the current block is intra, Δx and Δy are set to 0. If the prediction mode of the current block is inter prediction, Δx and Δy are set to the horizontal and vertical motion vectors of the current block. In another embodiment, if the current block is inter bi-prediction, Δx and Δy are set to the horizontal and vertical motion vectors in reference picture list 0. In still another embodiment, if the current block is inter bi-prediction, Δx and Δy are set to the horizontal and vertical motion vectors in reference picture list 1.

For still another embodiment, if the current block is inter bi-prediction, the inherited model parameters can be from the block in the previously coded slices/pictures in the reference lists. For example, if the horizontal and vertical parts of the motion vector in reference picture list 0 are Δx_{L0} and Δy_{L0}, the motion vector can be scaled to other reference pictures in the reference list 0 and 1. If the motion vector is scaled to the i^{th} reference picture in the reference list 0 as (Δx_{L0,i0}, Δy_{L0,i0}), the model can be from the block in the i^{th} reference picture in the reference list 0, and Δx and Δy are set to (Δx_{L0,i0}, Δy_{L0,i0}). For another example, if the horizontal and vertical parts of the motion vector in reference picture list 0 are Δx_{L0} and Δy_{L0}, the motion vector is scaled to the i^{th} reference picture in the reference list 1 as (Δx_{L0,i1} Δy_{L0,i1}). The model can be from the block in the i^{th} reference picture in the reference list 1, and Δx and Δy are set to (Δx_{L0,i1}, Δy_{L0,i1}).

In one embodiment, if the current slice/picture is a non-intra slice/picture, the inherited model parameters can be from the block in the previously coded slices/pictures. In one embodiment, the current block position is at (x, y) and the block size is w×h. The two value sets aₓ and a_{y} are defined as:

$${α}_{x} = \{ {α}_{x 1} , {α}_{x 2} , {α}_{x 3} , ... , {α}_{xn} \} , {α}_{xi} < {α}_{xj} if i < j ,$$

$${α}_{y} = \{ {α}_{y 1} , {α}_{y 2} , {α}_{y 3} , ... , {α}_{yn} \} , {α}_{yi} < {α}_{yj} if i < j .$$

All values in aₓ and a_{y} are positive numbers. Let

$$( {x}_{mid} , {y}_{mid} ) = ( x + \frac{w}{2} , y + \frac{h}{2} ) .$$

The inherited model parameters can be from the block at positions (x_{mid}+aₓᵢ×w, y_{mid}+a_{yi}×h), (x_{mid}+aₓᵢ×w, y_{mid}−a_{yi}×h), (x_{mid}−aₓᵢ×w, y_{mid}+a_{yi}×h), (x_{mid}−aₓᵢ×w, y_{mid}−a_{yi}×h), (x_{mid}+aₓᵢ×w, 0), (x_{mid}−aₓᵢ×w, 0), (0,y_{mid}+a_{yi}×h), (0, y_{mid}−a_{yi}×h), (x_{mid}±aₓᵢ×w, y_{mid}), (x_{mid}, y_{mid}±a_{yi}×h) of the previously coded slices/picture.

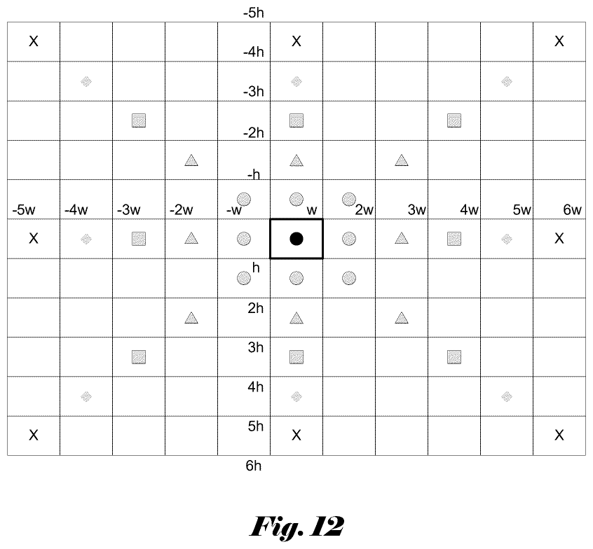

In one sub-embodiment, aₓ=a_{y}. For example, aₓ=a_{y}={1, 2, 3, 4, 5}. The inherited model parameters can be from the block at positions of the previously coded slices/picture depicted in FIG. 12.

In another sub-embodiment, aₓ≠a_{y}. For example, aₓ={1/2, 1, 3/2, 2, 5/2} and a_{y}={1, 2, 3, 4, 5}.

In another embodiment, the current block position is at (x, y) and the block size is w×h. The inherited model parameters can be from the block at positions (x+aₓᵢ×w, y+a_{yi}×h), (x+aₓᵢ×w, y−a_{yi}×h), (x−aₓᵢ×w, y+a_{yi}×h), (x−aₓᵢ×w, y−a_{yi}×h), (x+aₓᵢ×w, 0), (x−aₓᵢ×w, 0), (0, y+a_{yi}×h), (0, y−a_{yi}×h), (x±ᵢₐ×w, y), (x, y±a_{yi}×h) of the previously coded slices/picture.

In one sub-embodiment, aₓ=a_{y}. For example, aₓ=a_{y}={1, 2, 3, 4, 5}.

In another sub-embodiment, aₓ≠a_{y}. For example, a_x={1/2, 1, 3/2, 2, 5/2} and a_{y}={1, 2, 3, 4, 5}.

In one embodiment, the models from the positions closer to (x_{mid}, y_{mid}) are added into the final merge candidate list first. In another embodiment, the models from the positions closer to (x, y) are added into the final merge candidate list first.

In one embodiment, let δx and δy be two fixed positive numbers. The inherited model parameters can be from the block at positions (x_{mid}+aₓᵢ×δx, y_{mid}+a_{yi}×δy), (x_{mid}+aₓᵢ δx, y_{mid}−a_{yi}×δy), (x_{mid}−aₓᵢ×δx, y_{mid}+aₓᵢ×δy), (x_{mid}−aₓᵢ×δx, y_{mid}−a_{yi}×δy), (x_{mid}+aₓᵢ×δx, 0), (x_{mid}−aₓᵢ×δx, 0), (0,y_{mid}+a_{yi}×δy), (0,y_{mid}−a_{yi}×δy), (x_{mid}, aₓᵢ×δx, y_{mid}), (x_{mid}, y_{mid}±a_{yi}×δy) of the previously coded slices/picture.

In another embodiment, the current block position is at (x, y) and the block size is w×h. Let δx and δy be two fixed positive numbers The inherited model parameters can be from the block at positions (x+aₓᵢ×δx, y+a_{yi}×δy), (x+aₓᵢ×δx, y−a_{yi}×δy), (x−aₓᵢ×δx, y+a_{yi}×(δy), (x−aₓᵢ×δx, y−a_{yi}×δy), (x+aₓᵢ×δx,0), (x−aₓᵢ×δx,0), (0,y+a_{yi}×δy), (0,y−a_{yi}×δy), (x±aₓᵢ×δx, y), (x, y±a_{yi}×δy) of the previously coded slices/picture.

In another embodiment, the current block position is at (x, y) and the block size is w×h. The inherited model parameters can be from the block at some pre-defined positions (x′, y′) of the previously coded slices/picture. For one example, the positions are inside the corresponding area of the current encoding block, i.e., x<x′<x+w and y<y′<y+h. The inherited model parameters can be from the block at (x, y), (x+w−1, y), (x, y+h−1), (x+w−1, y+h−1), or (x+w/2, y+h/2). For another example, the positions are outside of the corresponding area of the current encoding block, i.e., x′<x+ or x′>x+w, and y′<y or y′>y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h),or (x+w, y+h).

In one embodiment, the previously coded picture that the inherited parameter model is from (i.e., the collocated picture) is one of the pictures in the reference lists.

The previous coded picture that the inherited parameter model is from is referred as the collocated picture hereafter.

In one embodiment, the collocated picture is signalled in the picture/slice header. The reference list and the reference index are signalled in the picture/slice header. For example, the collocated picture is selected as L0[0]. For another example, the collocated picture is selected as L1[0].

In one embodiment, the collocated picture is selected as the picture in the reference lists whose POC difference between the respective picture and the current picture is the smallest. For example, if the POC of current picture is 8, the POCs of pictures in reference list 0 are {7, 6, 5, 0} and POCs of pictures in reference list 1 are {7, 6, 5, 4}, then L0[0](equivalent to L1[0]) is selected since its POC difference is the smallest. In another sub-embodiment, if there are two pictures whose POC difference between the respective picture and the current picture are both the smallest, the picture with the smaller POC is selected. In another sub-embodiment, if there are two pictures whose POC difference between the respective picture and the current picture are both the smallest, the picture with the larger POC is selected. In another sub-embodiment, if there are two pictures whose POC difference between the respective picture and the current picture are both the smallest, the picture with smaller QP difference between the respective picture and the current picture is selected. Then L0[1](POC=4 and QP=26) is selected. In still another embodiment, if there are two pictures whose POC differences between the respective picture and the current picture are both the smallest, the picture with the smaller QP is selected. In still another embodiment, if there are two pictures, whose POC difference between the respective picture and the current picture are both the smallest, the picture with the larger QP is selected.

In one embodiment, the collocated picture is selected as the picture in the reference lists whose QP difference between the respective picture and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected. In another sub-embodiment, if there are multiple pictures in the reference lists whose QP difference between the respective picture and the current picture are the smallest, the picture with the smaller QP is selected. In another sub-embodiment, if there are multiple pictures whose QP difference between the respective picture and the current picture are the smallest, the picture with the larger QP is selected. In another sub-embodiment, if there are multiple pictures whose QP difference between the respective picture and the current picture are the smallest, the picture with the smaller POC distance is selected. In still another sub-embodiment, if there are multiple pictures whose QP difference between the respective picture and the current picture are the smallest, the picture with the smaller POC is selected. In still another sub-embodiment, if there are multiple pictures whose QP difference between the respective pictures and the current picture are the smallest, the picture with the larger POC is selected.

In one embodiment, the collocated picture is selected as the picture in the reference lists whose QP is the smallest. In another embodiment, the collocated picture is selected as the picture in the reference lists whose QP is the largest.

In one embodiment, the collocated picture is selected based on a combination of some or all of the methods mentioned above.

In one embodiment, the previously coded picture, which the inherited parameter model is from (i.e., the collocated picture), is the most recently coded I-picture. The cross-component model information of the most recently coded I-slice/picture is stored in a long-term reference buffer.

In one embodiment, the collocated picture and the position where the inherited parameter model is from, is determined by the motion vector of a neighbouring block. For example, if the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy. Δx and Δy are set to the L0 horizontal and vertical motion vector of the neighbouring block respectively, and the collocated picture is the L0 reference picture indicated by the L0 motion vector of the neighbouring block. In still another embodiment, if the neighbouring block is inter bi-prediction, Δx and Δy are set to the L1 horizontal and vertical motion vector of the neighbouring block respectively, and the collocated picture is the L1 reference picture indicated by the L1 motion vector of the neighbouring block. In one embodiment, the neighbouring block is the left block of the current block. In another embodiment, the neighbouring block is the above block of the current block.

In one embodiment, the positions in the previously coded slices/pictures where the inherited parameter model is from is determined by the motion vector of a neighbouring block. Let Δx and Δy be the horizontal and vertical displacements determined based on the selected motion vector of the neighbouring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

In another embodiment, the inherited model parameters can also be from the block positions in the patterns described in earlier paragraphs. The positions are centred at (x′, y′), where x′=x+Δx and y′=y+Δy, or where x′=x+w/2+Δx and y′=y+h/2+Δy. That is, denote the pre-defined positions as (x₁, y₁, (x₂, y₂), (x₃, y₃), . . . , (x_{N},y_{N}), the inherited model parameters can be from (x₁+Δx, y₁+Δy), (x₂+Δx, y₂+Δy), (x₃+Δx, y₃+Δy), . . . , (x_{N}+Δx, y_{N}+Δy), where Δx and Δy are the horizontal and vertical displacements determined based on the selected motion vector of the neighbouring block. For example, let the current block size be w×h. The two value sets aₓ and a_{y} are defined as:

$${α}_{x} = \{ {α}_{x 1} , {α}_{x 2} , {α}_{x 3} , ... , {α}_{xn} \} , {α}_{xi} < {α}_{xj} if i < j$$

$${α}_{y} = \{ {α}_{y 1} , {α}_{y 2} , {α}_{y 3} , ... , {α}_{yn} \} , {α}_{yi} < {α}_{yj} if i < j$$

All values in aₓ and a_{y} are positive numbers. The inherited model parameters can be from the block at positions (x′+aₓᵢ×w, y′+a_{yi}×h), (x′+aₓᵢ×w, y′−a_{yi}×h), (x′−aₓᵢ×w, y′+a_{yi}×h), (x′−aₓᵢ×w, y′−a_{yi}×h), (x′+aₓᵢ×w, 0), (x′−aₓᵢ×w, 0), (0,y′+a_{yi}×h), (0,y′−a_{yi}×h), (x′+aₓᵢ×w,y′), (x′−aₓᵢ×w,y′), (x′,y′+a_{yi}×h), (x′, y′−a_{yi}×h) of the previously coded slices/picture. For another example, let δx and δy be two fixed positive numbers. The inherited model parameters can be from the block at positions (x′+aₓᵢ×δx, y′+a_{yi}×δy), (x′+aₓᵢ×δx, y′−a_{yi}×δy), (x′−aₓᵢ×δx, y′+a_{yi}×δy), (x′−aₓᵢ×δx, y′−a_{yi}×δy), (x′+aₓᵢ×δx, 0), (x′−aₓᵢ×δx, 0), (0,y′+a_{yi}×δy), (0,y′−a_{yi}×δy), (x′+aₓᵢ×δx,y′), (x′−aₓᵢ×δx,y′), (x′,y′+a_{yi}×δy), (x′, y′−a_{yi}×δy) of the previously coded slices/picture. For another example, the inherited model parameters can be from the block at some pre-defined positions relative to (x′, y′) of the previously coded slices/picture. The positions an be (x′, y′), (x′+w−1, y′), (x′, y′+h−1), (x′+w−1, y′+h−1),

$$( {x}^{′} + \frac{w}{2} , {y}^{′} + \frac{h}{2} ) .$$

For an another example, the positions can be (x′−1, y′), (x′, y′−1), (x′−1, y′−1), (x′+w, y′), (x′+w−1, y′−1), (x′+w, y′-1), (x′, y′+h), (x′-1, y′+h−1), (x′−1, y′+h), (x′+w, y′+h−1), (x′+w−1, y′+h), (x′+w, y′+h)

In one embodiment, the neighbouring block can be at a pre-defined position. For example, the position can be at the A0 position as depicted in FIG. 7. The pre-defined position can also be at A1, B0, B1, B2 as depicted in FIG. 7. For example, if the block at the pre-defined position is not an inter block, no neighbouring block is selected. For example, if the block is an inter-block, the L0 motion is selected. If L0 motion vector is not available, the L1 motion vector is selected. For another example, if the block is an inter-block, the L1 motion vector is selected, if L1 motion vector is not available, the L0 motion vector is selected.

In another embodiment, when selecting the neighbouring block, there can be a list of pre-defined positions. The positions are placed according to the checking order. For example, the positions can be the spatial position as depicted in FIG. 7. The selected neighbouring block can be the first position in the list that is an inter block. The L0 motion vector is first selected. If the L0 motion vector is not available, select the L1 motion vector. For another example, the L1 motion vector is first selected. If the L1 motion vector is not available, select the L0 motion vector

For another example, the positions in the list are checked in the pre-defined checking order. For each position, the L0 motion vector is first checked, and then the L1 motion vector. For another example, the L1 motion vector is first checked, and then the L0 motion vector. The selected motion vector is the first whose reference picture is the collocated picture. That is, the collocated picture is determined before selecting the neighbouring motion vector. The collocated picture can be determined based on methods described above (i.e., in earlier paragraphs in this section).

In one embodiment, the horizontal and vertical displacements Δx and Δy are determined based on the selected motion vector of the neighbouring block. In one sub-embodiment, for example, if the reference picture of the selected motion vector and the collocated picture are the same picture, Δx equals to the horizonal part of the selected motion vector and Δy equals to the vertical part of the selected motion vector. In one sub-embodiment, for another example, if the reference picture of the selected motion vector and the collocated picture are not the same. The reference picture can be one of the pictures in the reference list, where the collocated picture is signalled in the picture/slice header or determined based on methods mentioned above. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb).

In one embodiment, the inherited model parameters are derived by using the luma and chroma reconstruction samples of the collocated block. Let the current block position be at (x, y) and the block size is w×h. The collocated block is a block positioned at (x′, y′) in the collocated picture with block size w×h, when the inherited model is from position (x′, y′). For another example, the collocated block can be a block positioned at (x′, y′) in the collocated picture with block size m x n, where m and n are fixed positive values. For example, the collocated block can be at (x, y). For another example, if Δx and Δy are the L0 horizontal and vertical motion vector of the neighbouring block, and the collocated picture is the L0 reference picture indicated by the L0 motion vector of the neighbouring block, the collocated block can be at (x+Δx, y+Δy) in the collocated picture. (x′, y′) can be the block positions in the patterns described in earlier paragraphs. For example, (x′, y′) can be (x+aₓᵢ×w, y+a_{yi}×h), (x+aₓᵢ×w, y−a_{y}×h), (x−aₓᵢ×w, y+a_{y}×h), (x−aₓᵢ×w, y−a_{yi}×h), (x+aₓᵢ×w, 0), (x−aₓᵢ×w, 0), (0, y+a_{yi}'h), (0, y−a_{yi}×h), (x+aₓᵢ×w, y), (x−aₓᵢ×w,y), (x,y+a_{yi}×h), (x,y−a_{yi}×h).

In one embodiment, the cross-component parameter model can be inherited from more than one previously coded pictures. The number of collocated pictures (i.e., the previously coded pictures, which the model parameters are inherited from) can be signalled in PH, SH, PPS or SPS, or can be determined by some pre-defined rules.

In one embodiment, the cross-component parameter model can be inherited from more than one previously coded pictures. The cross-component parameter model can be inherited from any picture in a picture set, which contains N previously coded pictures. For example, the picture set can be the reference lists. The pictures from which the cross-component parameter models are inherited from can be determined with methods described in earlier paragraphs in this section. For example, the methods can be selecting the picture with the smaller QP, larger QP, smaller QP difference from the current picture, smaller POC difference from the current picture, and/or the combination thereof.

In one embodiment, the cross-component parameter model can be inherited from more than one previously coded pictures. The cross-component parameter model can be inherited from any picture in a picture set, which contains N previously coded pictures. An index can be signalled/parsed in the bitstream to indicate the selected picture. The index ranges from 0 to N−1.

In one sub-embodiment, the picture, where the POC difference between it and the current picture is smaller, is associated with the smaller index. In another sub-embodiment, the picture, where the QP difference between it and the current picture is smaller, is associated with the smaller index. In another sub-embodiment, the picture with a smaller QP is associated with the smaller index. In another sub-embodiment, the picture with a larger QP is associated with the smaller index.

### Inheriting Non-Adjacent Spatial Neighbouring Models

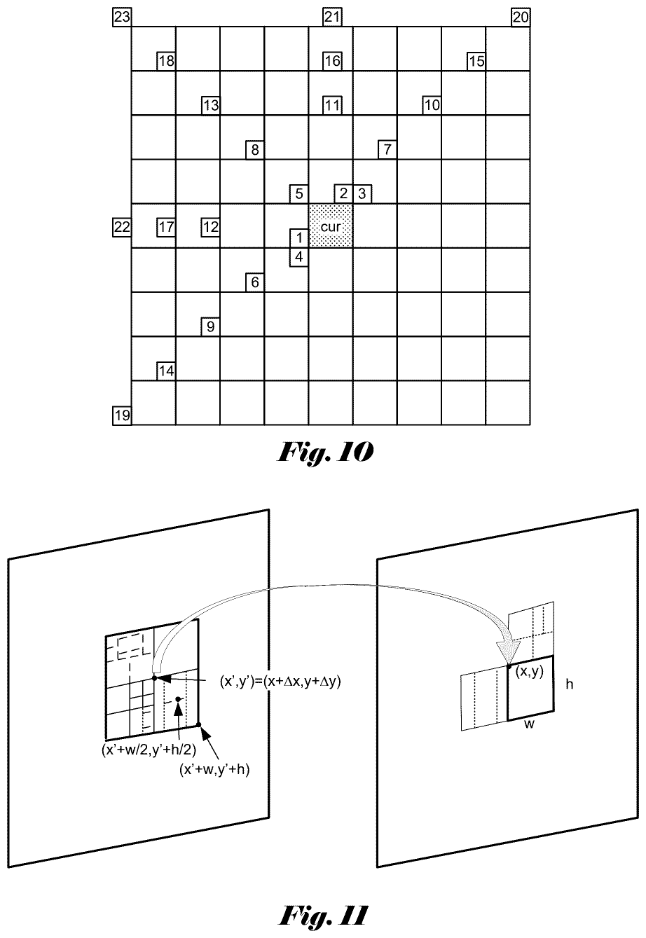

For another embodiment, the inherited model parameters can be from blocks that are non-adjacent spatial neighbouring blocks. The models from blocks at pre-defined positions are added into the candidate list in a pre-defined order. For example, the pre-defined the pre-defined order are the same as those of non-adjacent spatial neighbouring candidates for inter merge mode. For example, the positions and the order can be as depicted in FIG. 10. The positions of the numbered squares are the pre-defined positions. The number inside each square indicate the pre-defined order. The distances between each position are proportional to the width and height of current coding block.

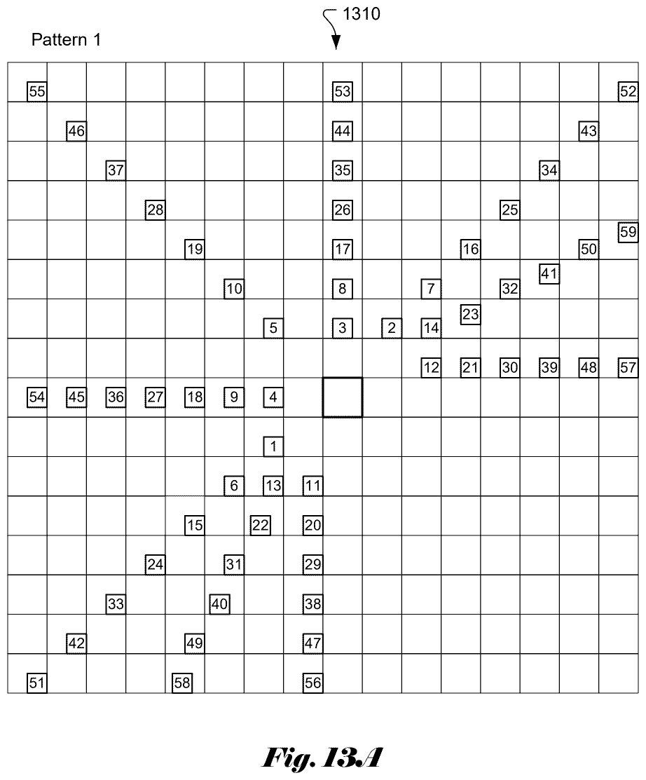

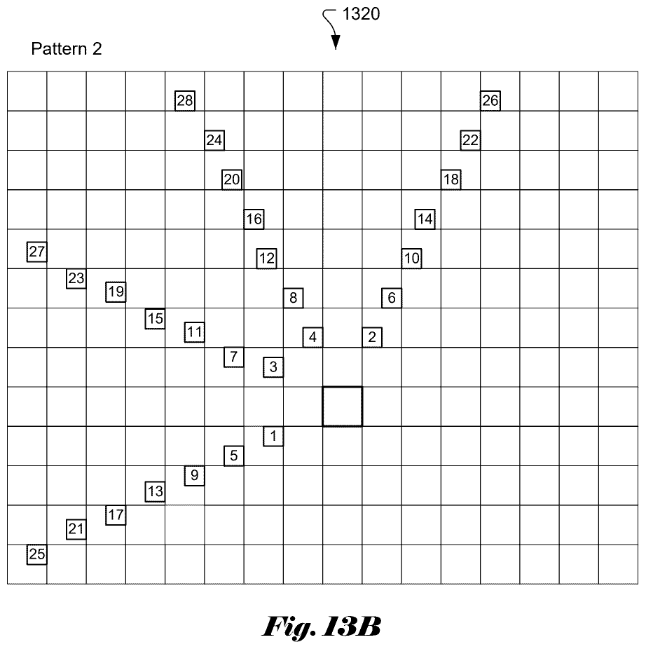

For still another embodiment, the maximum number of inherited models from non-adjacent spatial neighbours that can be added into the candidate list is smaller than the number of pre-defined positions. For example, if the pre-defined positions are as depicted in FIGS. 13A-B, where two patterns (1310 and 1320) are shown. If the maximum number of inherited models from non-adjacent spatial neighbours hat can be added into the candidate list is N, the search pattern 2 is used (i.e., the models from positions in patter 2 are added) only when the number of available models from positions in search pattern 1 is smaller than N.

Inheriting Model Parameters from History Table

In one embodiment, the inherited model parameters can be from a cross-component model history table. The cross-component models in the history table can be added into the candidate list according to a pre-defined order. In one embodiment, the adding order of historical candidates can be from the beginning of the table to the end of the table. In another embodiment, the adding order of historical candidates can be from a certain pre-defined position to the end of the table. In another embodiment, the adding order of historical candidates can be from the end of the table to the beginning of the table. In another embodiment, the adding order of historical candidates can be from a certain pre-defined position to the beginning of the table. In another embodiment, the adding order of historical candidates can be in an interleaved manner (e.g., the first candidate added is from the beginning of the table, the second added candidate is from the end of the table and so on).

In one embodiment, single cross-component model history table can be maintained for storing the previous cross-component model, and the cross-component model history table can be reset at the start of the current picture, current slice, current tile, every M CTU rows or every N CTUs, where N and M can be any value greater than 0. In another embodiment, the cross-component model history table can be reset at the end of the current picture, current slice, current tile, current CTU row or current CTU.

Inheriting from Fusion Mode

Fusion mode refers to the mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by chroma intra fusion mode, the model parameters for obtaining the CCP coded intra prediction are inherited and further refined.

In one embodiment, in addition to inheriting and refining the CCP model parameters, the fusion weight, the coding mode of non-CCP coded intra prediction are also inherited. That is, the chroma intra fusion mode is inherited.

### Candidate List Construction

In one embodiment, the candidate list is constructed by adding candidates in a pre-defined order until the maximum candidate number is reached. The candidates added may include all or some of the aforementioned candidates, but not limited to the aforementioned candidates. For example, the candidate list may include spatial neighbouring candidates, temporal neighbouring candidate, historical candidates, non-adjacent neighbouring candidates. For another example, the candidate list can include the same candidates as previous example, but the candidates are added into the list in a different order.

In another embodiment, if all the pre-defined neighbouring and historical candidates are added but the maximum candidate number is not reached, some default candidates are added into the candidate list until the maximum candidate number is reached.

In one sub-embodiment, the default candidates include but not limited to the candidates described below. The final scaling parameter a is from the set {0, ⅛, −⅛, + 2/8, − 2/8, +⅜, −⅜, + 4/8}, and the offset parameter β=1/(1»bit_depth) or is derived based on neighbouring luma and chroma samples. For example, if the average value of neighbouring luma and chroma samples are lumaAvg and chromaAvg, then β is derived by β=chromaAvg−α·lumaAvg.

In another embodiment, a default candidate can be an earlier candidate with a delta scaling parameter refinement. For example, if the scaling parameter of an earlier candidate is a, the scaling parameter of a default candidate is (α+Δα), where Δα can be from the set {⅛, −⅛, + 2/8, − 2/8, +⅜, −⅜, + 4/8}. And the offset parameter of a default candidate will be derived by (α+Δα) and the average value of neighbouring luma and chroma samples of the current block.

### Signalling the Inherited Candidate Index in the List

An on/off flag can be signalled to indicate if the current block inherits the cross-component model parameters from neighbouring blocks or not. The flag can be signalled per CU/CB, per PU, per TU/TB, or per colour component, or per chroma colour component. A high level syntax can be signalled in SPS, PPS (Picture Parameter Set), PH (Picture header) or SH (Slice Header) to indicate if the proposed method is allowed for the current sequence, picture, or slice.

The maximum allowed candidate number is signalled to indicate the maximum size of the merge candidate list. The number can be signalled per CU/CB, per PU, per TU/TB, or per colour component, or per chroma colour component. A high level syntax can be signalled in SPS, PPS, PH or SH to indicate if the proposed method is allowed for the current sequence, picture, or slice. The maximum allowed candidate number of the proposed method can be shared with the maximum allowed candidate number for inter merge mode.

If the current block inherits the cross-component model parameters from neighbouring blocks, the inherited candidate index is signalled. The index can be signalled (e.g., signalled using truncate unary code, Exp-Golomb code, or fix length code) and shared among both the current Cb and Cr blocks. For another example, the index can be signalled per colour component. For example, one inherited candidate index is signalled for Cb component, and another inherited candidate index is signalled for Cr component. For another example, it can use chroma intra prediction syntax (e.g., IntraPredModeC[xCb][yCb]) to store the inherited index.

If the current block inherits the cross-component model parameters from neighbouring blocks, the current chroma intra prediction mode (e.g., IntraPredModeC[xCb][yCb] as defined in VVC standard) is temporally set to a cross-component mode (e.g., CCLM_LA) at the bitstream syntax parsing stage. Later, at the prediction stage or reconstruction stage, the candidate list is derived, and the inherited candidate model is then determined by the inherited candidate index. After obtaining the inherited model, the coding information of the current block is then updated according to the inherited candidate model. The coding information of the current block includes but not limited to the prediction mode (e.g., CCLM_LA or MMLM_LA), related sub-mode flags (e.g., CCCM mode flag), prediction pattern (e.g., GLM pattern index), and the current model parameters. Then, the prediction of the current block is generated according to the updated coding information.

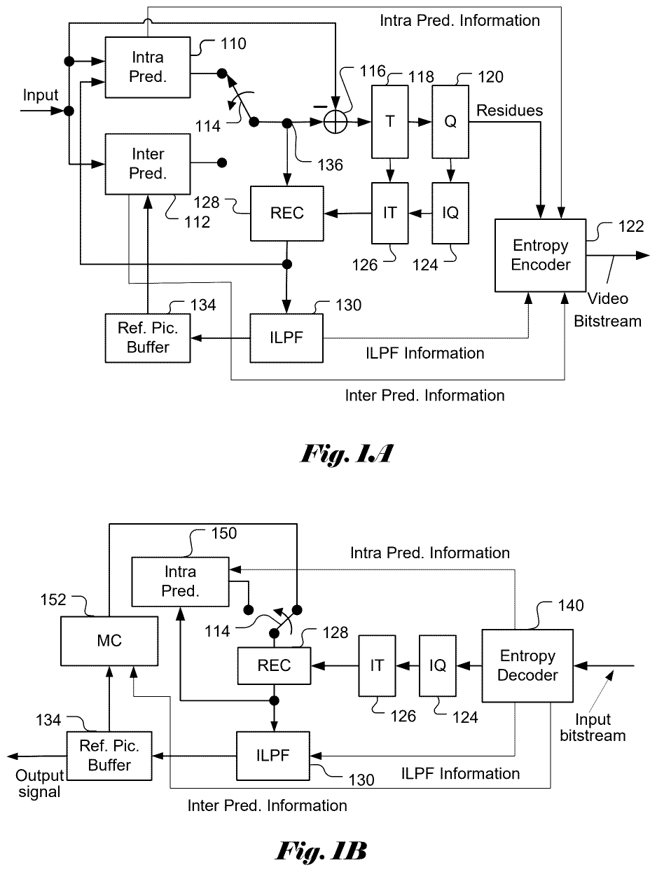

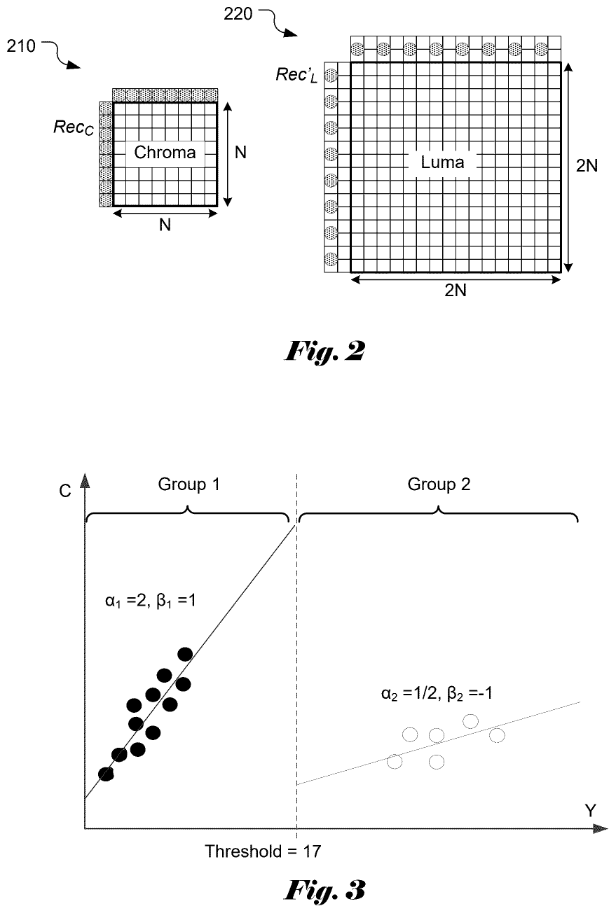

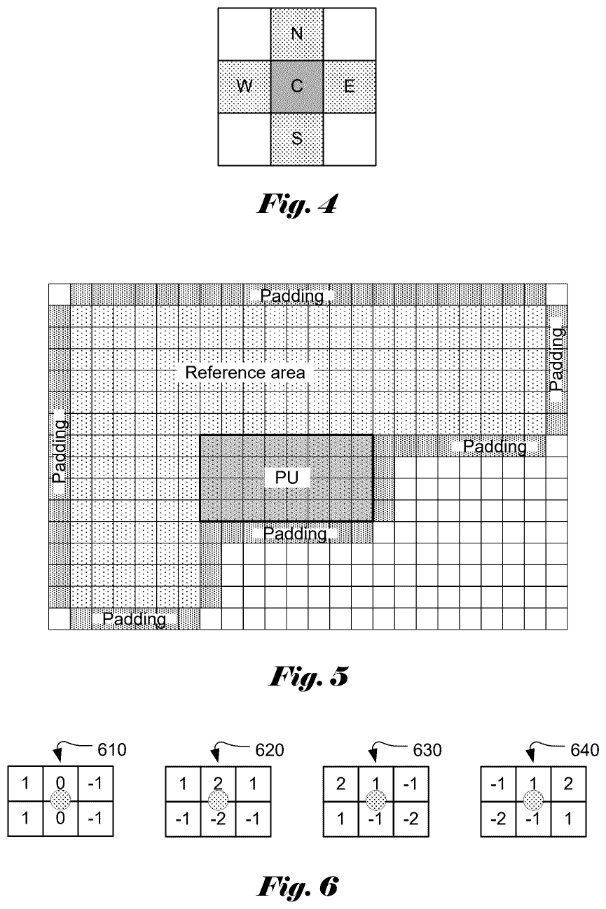

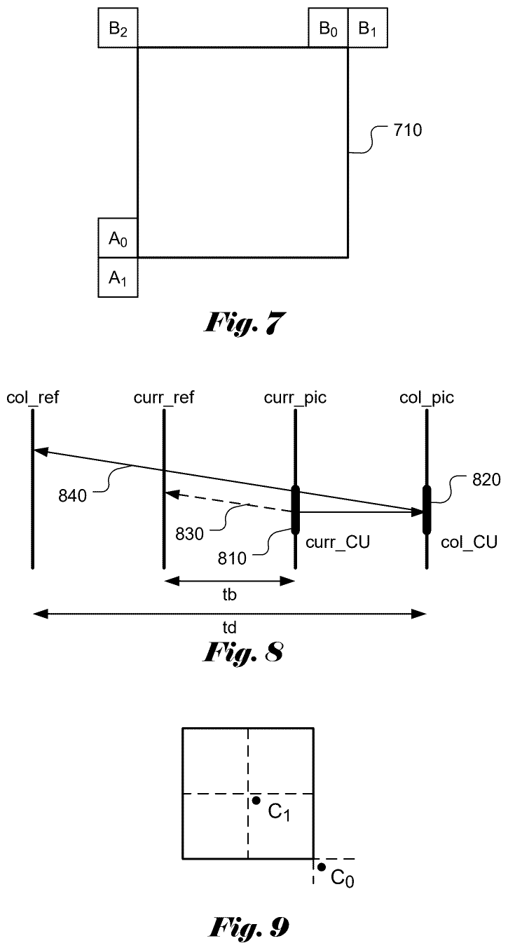

Any of the foregoing proposed methods can be implemented in encoders and/or decoders. For example, any of the cross-component prediction model derivation methods can be implemented in an inter/intra prediction modules of an encoder, and/or an inter/intra prediction modules of a decoder. Alternatively, any of the proposed methods can be implemented as circuits coupled to the inter/intra prediction modules of the encoder and/or the inter/intra prediction modules of the decoder, so as to provide the information needed by the inter/intra prediction modules. For example, a coding system using the cross-component prediction model derivation methods can be implemented in the reference encoder/decoder in FIGS. 1A-B. For example, any of the proposed cross-component prediction model derivation can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed cross component prediction model derivation methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

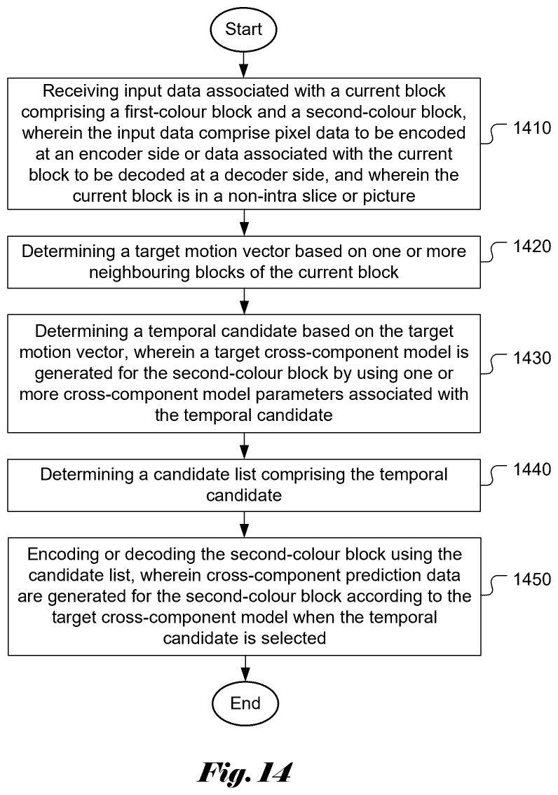

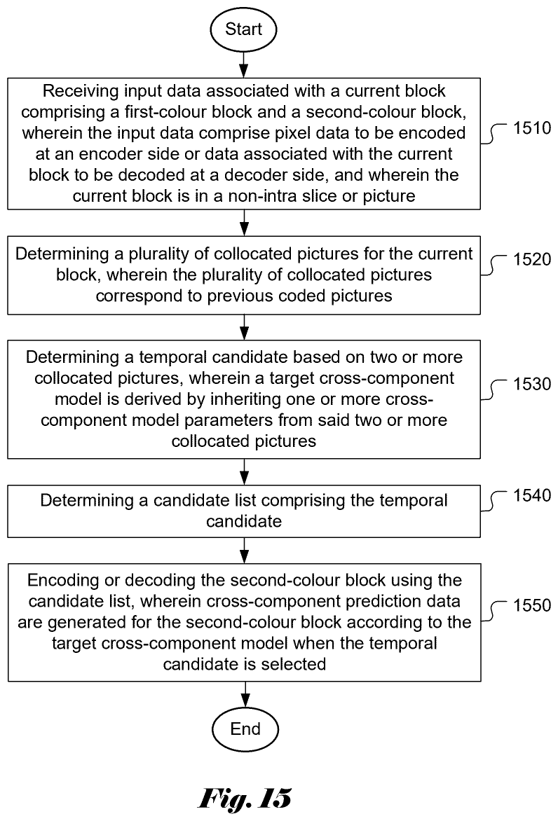

FIG. 14 illustrates a flowchart of an exemplary video coding system that derives a motion vector from a neighboring block to determine a temporal candidateaccording to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block comprising a first-colour block and a second-colour block re received in step 1410, wherein the input data comprise pixel data to be encoded at an encoder side or data associated with the current block to be decoded at a decoder side, and wherein the current block is in a non-intra slice or picture. A target motion vector is determined in step 1420 based on one or more neighbouring blocks of the current block. A temporal candidate is determined in step 1430 based on the target motion vector, wherein a target cross-component model is generated for the second-colour block by using one or more cross-component model parameters associated with the temporal candidate. A candidate list comprising the temporal candidate is determined in step 1440. The second-colour block is encoded or decoded using the candidate list in step 1450, wherein cross-component prediction data are generated for the second-colour block according to the target cross-component model when the temporal candidate is selected.

FIG. 15 illustrates a flowchart of an exemplary video coding system that inherits cross-component models from two or more previous coded pictures according to an embodiment of the present invention. According to this method, input data associated with a current block comprising a first-colour block and a second-colour block are received in step 1510, wherein the input data comprise pixel data to be encoded at an encoder side or data associated with the current block to be decoded at a decoder side, and wherein the current block is in a non-intra slice or picture. A plurality of collocated pictures for the current block is determined in step 1520, wherein the plurality of collocated pictures correspond to previous coded pictures. A temporal candidate is determined in step 1530 based on two or more collocated pictures, wherein a target cross-component model is derived by inheriting one or more cross-component model parameters from said two or more collocated pictures. A candidate list comprising the temporal candidate is determined in step 1540. The second-colour block is encoded or decoded in step 1550 using the candidate list, wherein cross-component prediction data are generated for the second-colour block according to the target cross-component model when the temporal candidate is selected.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side, and wherein the current block is in a non-intra slice or picture;
determining a target motion vector based on one or more neighbouring blocks of the current block;
determining a temporal candidate based on the target motion vector, wherein a target cross-component model is generated for the second-colour block by using one or more cross-component model parameters associated with the temporal candidate;
determining a candidate list comprising the temporal candidate; and
encoding or decoding the second-colour block using the candidate list, wherein cross-component prediction data are generated for the second-colour block according to the target cross-component model when the temporal candidate is selected.

2. The method of claim 1, wherein said one or more neighbouring blocks are located at one or more pre-defined positions.

3. The method of claim 2, wherein the target motion vector selected corresponds to a L0 or L1 motion vector.

4. The method of claim 2, wherein if a target neighbouring block of said one or more neighbouring blocks is not an inter block, the target neighbouring block of said one or more neighbouring blocks is not selected for the current block for said determining the temporal candidate.

5. The method of claim 1, wherein said one or more neighbouring blocks of the current block correspond to a list of pre-defined positions and a target neighbouring block is selected from the list of pre-defined positions according to a pre-defined checking order.

6. The method of claim 5, wherein the target neighbouring block corresponds to a first position being an inter block in the list of pre-defined positions.

7. The method of claim 5, wherein the target neighbouring block corresponds to a first position in the list of pre-defined positions, and wherein the first position has a reference picture as a collocated picture of the current block.

8. The method of claim 1, wherein the target cross-component model is inherited from a previously coded picture and the previously coded picture is selected from reference pictures in one or more reference lists.

9. The method of claim 8, wherein a target reference picture selected from the reference pictures in said one or more reference lists is signalled in a picture or slice header.

10. The method of claim 8, wherein a target reference picture is selected implicitly from the reference pictures in said one or more reference lists according to a set of pre-defined rules.

11. The method of claim 10, wherein the set of pre-defined rules comprises selecting a candidate reference picture that has a smallest POC (Picture Order Count) difference or a smallest QP (Quantization Parameter) difference between respective reference pictures and a current picture, or has a smallest QP among the reference pictures as the target reference picture.

12. The method of claim 10, wherein the set of pre-defined rules comprises selecting a candidate reference picture that corresponds to a most recently coded I-picture as the target reference picture.

13. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side, and wherein the current block is in a non-intra slice or picture;
determine a target motion vector based on one or more neighbouring blocks of the current block;
determine a temporal candidate based on the target motion vector, wherein a target cross-component model is generated for the second-colour block by using one or more cross-component model parameters associated with the temporal candidate;
determine a candidate list comprising the temporal candidate; and
encode or decode the second-colour block using the candidate list, wherein cross-component prediction data are generated for the second-colour block according to the target cross-component model when the temporal candidate is selected.

14. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side, and wherein the current block is in a non-intra slice or picture;
determining a plurality of collocated pictures for the current block, wherein the plurality of collocated pictures correspond to previous coded pictures;
determining a temporal candidate based on two or more collocated pictures, wherein a target cross-component model is derived by inheriting one or more cross-component model parameters from said two or more collocated pictures;
determining a candidate list comprising the temporal candidate; and
encoding or decoding the second-colour block using the candidate list, wherein cross-component prediction data are generated for the second-colour block according to the target cross-component model when the temporal candidate is selected.

15. The method of claim 14, wherein a total number for the plurality of collocated pictures is signalled or parsed in a bitstream.

16. The method of claim 15, wherein the total number for the plurality of collocated pictures is signalled or parsed in PH (Picture Header), SH (Slice Header), PPS (Picture Parameter Set) or SPS (Sequence Parameter Set) of the bitstream.

17. The method of claim 14, wherein the plurality of collocated pictures corresponds to a picture set consisting of N previous coded pictures.

18. The method of claim 17, wherein one target index is signalled or parsed from a bitstream to indicate one of said two or more collocated pictures selected from the picture set.

19. The method of claim 18, wherein an index for a member picture in the picture set has a smaller value if POC (Picture Order Count) difference between the member picture and a current picture is smaller.

20. The method of claim 18, wherein an index for a member picture in the picture set has a smaller value if picture-level QP (Quantization Parameter) difference between the member picture and a current picture is smaller.

21. The method of claim 18, wherein an index for a member picture in the picture set has a smaller value if picture-level QP (Quantization Parameter) of the member picture is smaller.

22. The method of claim 18, wherein an index for a member picture in the picture set has a smaller value if picture-level QP (Quantization Parameter) of the member picture is larger.

23. The method of claim 17, wherein said two or more collocated pictures are selected from the picture set according to a set of pre-defined rules.

24. The method of claim 23, wherein the set of pre-defined rules corresponds to selecting one or more candidate pictures from the picture set with a smaller QP, larger QP, smaller QP difference from a current picture, smaller POC difference from a current picture, and/or a combination thereof.

25. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side, and wherein the current block is in a non-intra slice or picture;
determine a plurality of collocated pictures for the current block, wherein the plurality of collocated pictures correspond to previous coded pictures;
determine a temporal candidate based on two or more collocated pictures, wherein a target cross-component model is derived by inheriting one or more cross-component model parameters from said two or more collocated pictures;
determine a candidate list comprising the temporal candidate; and
encode or decode the second-colour block using the candidate list, wherein cross-component prediction data are generated for the second-colour block according to the target cross-component model when the temporal candidate is selected.
